(19) United States
(12) Patent Application Publication
(10) Pub. No.: US 2010/0145760 A1
(43) Pub. Date: Jun. 10, 2010

(54) METHODS AND APPARATUS TO PROCESS NETWORK ACCESS SERVICE ORDERS

(76) Inventors: William Cambre, Port Orange, FL (US); Sidney Heffington, Lawrenceville, GA (US)

Correspondence Address: AT&T Legal Department - HFZ;ATTN. Patent Docketing, One AT&T Way, Room 2A-207, Bedminstor, NJ, 07921, US

(21) Appl. No.: 12/332,135

(22) Filed: Dec. 10, 2008

(51) Int. Cl. G06Q 10/00

(52) U.S. Cl. 705/9

(57) ABSTRACT

Methods and apparatus to process network access service orders are disclosed herein. An example apparatus to enable an entity to automatically process a network access service order associated with a subscriber includes a database to store information related to a plurality of access providers, the information including estimated periods of time for respective ones of the access providers to process access service requests (ASRs); and a service order coordinator to schedule creation and conveyance of a first ASR based on an estimated due date of a second ASR and at least one of the estimated periods of time in the database

### FIELD OF THE DISCLOSURE

The present disclosure relates generally to providing access to communication systems and, more particularly, to methods and apparatus to process network access service orders.

### BACKGROUND

Entities that need and/or desire access to a network such as the Internet typically employ the services of a telecommunications company capable of providing such access. For example, Internet service providers (ISPs) have the capacity to deliver network access to residences, commercial buildings, mobile devices, or any other device or entity having the equipment necessary to connect to a network. Entities requesting access to the network provide the ISP with certain information, such a geographic location, desired service type or specifications, equipment information, etc., which the ISP uses to link the entity to a portion of the network, such as a local area network (LAN) and/or a wide area network (WAN).

In many instances, the ISP does not have direct access to the physical components of the network, such as transmission lines and/or switching/routing equipment located at a central office (CO) of the LAN, the WAN, or any other type of network. Thus, to connect the requesting entity to the network, ISPs often require the cooperation of one or more external organizations that control one or more aspects of the network. In particular, most ISPs work with an access provider such as a local exchange carrier (LEC), which manages and/or controls the infrastructure of a local access and transport area (LATA). The ISP places requests with the LEC to facilitate the connection of the requesting entity to the network equipment in a certain geographic location, such as a nearby central office.

### BRIEF DESCRIPTION OF THE DRAWINGS

FIG. 1 is a schematic illustration of an example communication system including an Internet service provider (ISP) capable of processing network access service orders from a plurality of entities.

FIG. 2 is a block diagram of an example apparatus that may be used to implement the example service order coordinator of FIG. 1.

FIG. 3 is an example entry in the example record database of FIG. 1 corresponding to an example service order placed by the example subscriber of FIG. 1.

FIG. 4 is an example vendor provisioning time table stored in the example vendor tables of FIG. 1.

FIGS. 5A-C are schematic illustrations of example access network configurations that can be supported by the example ISP of FIG. 1.

FIGS. 6A and 6B are a flow diagram representative of example machine readable instructions that may be executed to implement the example access capacity management system of FIG. 1 and/or the example service order coordinator of FIG. 1 to automatically process a service order.

FIG. 7 is a block diagram of an example processor system that may be used to execute the machine readable instructions of FIGS. 6A and 6B to implement the example access capacity management system of FIG. 1.

### DETAILED DESCRIPTION

Although the following discloses example methods, apparatus, systems, and/or articles of manufacture including, among other components, firmware and/or software executed on hardware, it should be noted that such methods, apparatus, systems, and/or articles of manufacture are merely illustrative and should not be considered as limiting. For example, it is contemplated that any or all of the firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

An entity that needs and/or desires connectivity to a network such as the Internet is often only required to place a service order with, for example, an Internet service provider (ISP). Preferably, the participation of the requesting entity (referred to herein as a subscriber) in the process of completing the network connection is minimal and, ideally, ends with the placement of the service order with the ISP. Behind the scenes, however, the process of fulfilling the service order and providing connectivity to the network is complex and presents financial and logistical challenges to the ISP. In particular, processing a service order involves a plurality of configuration steps and/or stages, some or all of which are interdependent. That is, certain configuration stages cannot be started or processed beyond a certain point until another configuration stage is complete. Often, the completion of one or more configuration stages is not under the direct control of the ISP. Rather, the ISP may endure periods of waiting, during which one or more external organizations perform connectivity services described in greater detail herein.

Such circumstances have adverse affects on the ability of the ISP to efficiently process service orders. For example, the average pendency of service orders is prolonged due to periods of delay between the configuration stages. The ISP must also dedicate additional resources and/or redirect other resources to the coordination of the configuration stages. Of course, the subscriber experiences a period of non-connectivity during the pendency of the service order. Therefore, shorter service order pendency, at a minimum, avoids a negative initiation of the subscriber relationship with the ISP, promotes customer loyalty, improves quality of service and quality of service reviews, leads to new and repeat business, etc. Additionally, a reduction of resources dedicated to processing service orders enables an ISP to focus its efforts on other issues such as, for example, service maintenance, repair, upgrades, technical support, etc.

The example methods, apparatus, systems, and/or articles or manufacture described herein can be used to efficiently provide network connectivity to a plurality of subscribers by automatically processing a series of configuration requests and responses in a streamlined manner. In particular, the example methods, apparatus, systems, and/or articles of manufacture described herein automatically create, coordinate, and send a plurality of access service requests (ASRs) to one of a plurality of access providers (referred to herein as vendors) capable of connecting a subscriber to the network. The term ‘access service request’ or ‘ASR’ refers to a standardized form and/or guideline established by the Order and Billing Forum (OBF) to homogenize the transmission of information between entities ordering network access, such as subscribers, and entities providing network access, such as vendors. A standard ASR includes a plurality of fields to be populated by an ordering entity including, for example, circuit identifier(s), geographic location(s), service specification(s), network equipment setting(s), critical due date(s), etc.

In some instances, the ISP does not have direct access to the network infrastructure, such as the transmission lines and/or the switching/routing equipment at a central office (CO), needed to connect the subscriber to the network. In some instances, to provide the subscriber Internet connectivity, an ISP communicatively couples the subscriber with a point of presence (POP) (which may or may not be controlled by the ISP), which includes a downstream network device such as an Ethernet gateway switch (EGS). The EGS can link the subscriber to the vast network resources available over a plurality of local area networks (LANs) and/or wide-area networks (WANs) and/or, more generally, to the Internet. However, to place the subscriber in communication with the EGS, the ISP must often rely on at least one vendor that has control over the infrastructure of a switched network capable of establishing such a connection.

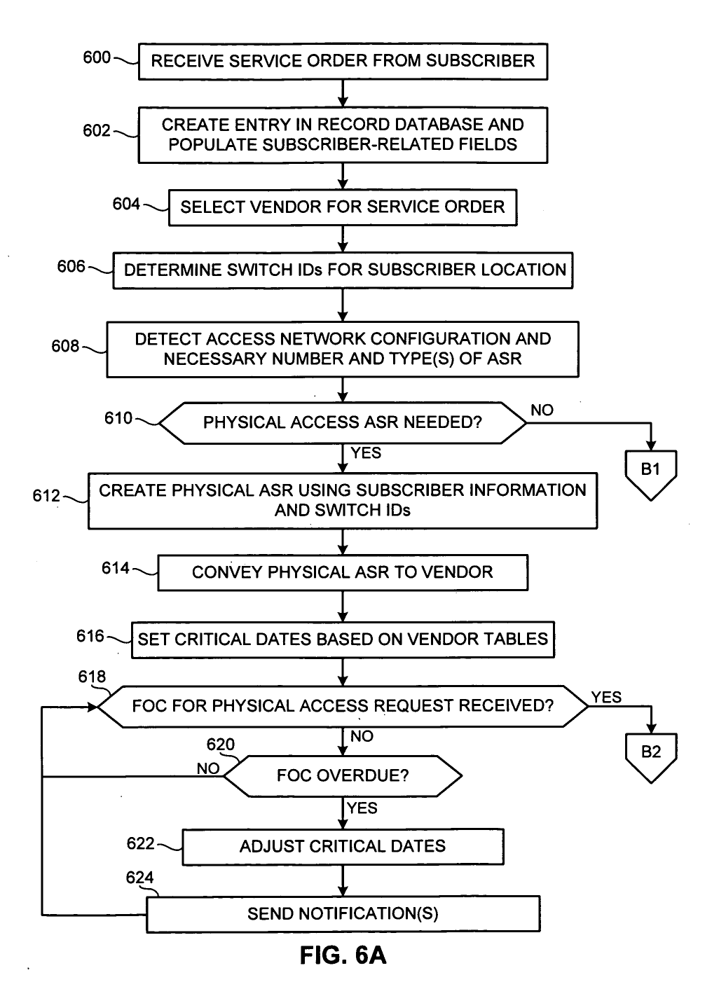

Thus, the ISP interacts with and/or cooperates with a vendor on behalf of a subscriber. Specifically, in response to receiving a service request, such as a request to subscribe to Internet access, from the subscriber, the ISP places one or more ASRs with the vendor. The ASR(s) include information associated with the subscriber and/or the subscriber premises requesting connectivity. The number and/or type(s) of ASR(s) to be conveyed to the vendor may vary depending on, for example, the type of network to which the connection is being established, whether the service order is a request for a new connection, a disconnection, or a change of connection, whether physical access to certain network devices has already been established, etc. Such dependencies are described in greater detail below in connection with FIGS. 5A-C, 6A and 6B.

The vendor uses the information in the ASR(s) to establish a connection between the subscriber and an access network controlled by the vendor such as, for example, an Ethernet switched network, an Ethernet over SONET network, the plain old telephone service (POTS), etc. The example methods, apparatus, systems, and/or articles of manufacture described herein are capable of determining a type of access network to which the subscriber will be connected and, thus, the number and/or type of ASR(s) that will be required to link the subscriber to the EGS of the ISP.

In past systems, when the ISP is required to place multiple ASRs with the vendor to provide network connectivity to the subscriber, the ISP waited for a first ASR to be processed, fulfilled, and returned by the vendor before a second ASR could be created and conveyed to the vendor. In other words, at least some of the ASRs to be created and conveyed to the vendor were interdependent. The example methods, apparatus, systems, and/or articles or manufacture described herein increase the efficiency of the processing of interdependent ASRs by, for example, determining an expected date of completion for some or all of the ASRs sent to a vendor, provisioning resources to automatically create one or more interdependent ASRs, and sending the one or more completed ASRs to the vendor. Because many ISPs work with a plurality of vendors to connect a plurality of subscriber in different geographic locations, the dates of completion, expected dates of completion, estimated dates of completion, and/or any other critical dates associated with different ASRs vary from vendor to vendor and among geographic locations of the subscribers. The example methods, apparatus, systems, and/or articles of manufacture described herein maintain database(s) and/or tables to set and track these critical dates and/or other information associated with each vendor. Processing and coordination of interdependent ASRs, other configuration steps, and/or critical dates are adjusted according to the database(s) by, for example, generating and conveying ASRs in accordance with the tables of the database(s) and the critical dates stored therein.

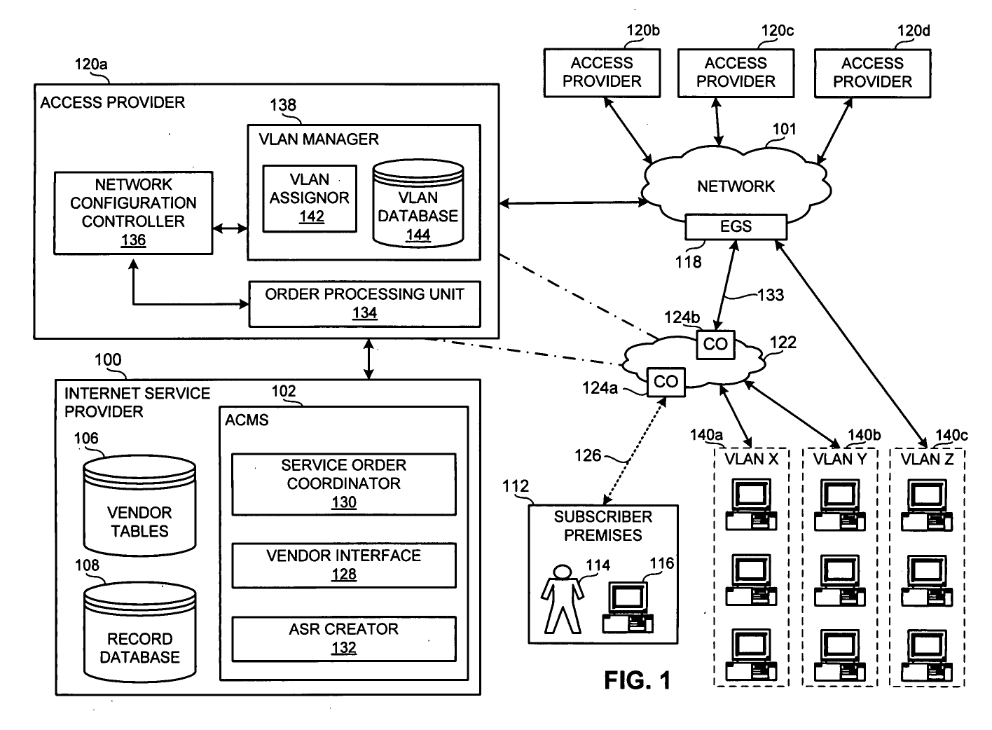

FIG. 1 is a schematic illustration of an example communication system including an Internet service provider (ISP) 100 capable of processing service orders from a plurality of entities to provide connectivity to a network 101. In the illustrated example of FIG. 1, the example ISP 100 includes an access capacity management system (ACMS) 102, vendor tables 106, and a record database 108. While an example manner of implementing the ISP 100 of FIG. 1 has been illustrated in FIG. 1, one or more of the elements, processes and/or devices illustrated in FIG. 1 may be combined, divided, re-arranged, omitted, eliminated and/or implemented in any other way. Further, the example ACMS 102, the example vendor tables 106, the example record database 108, and/or, more generally, the example ISP 100 of FIG. 1 may be implemented by hardware, software, firmware and/or any combination of hardware, software and/or firmware. Thus, for example, any of the example ACMS 102, the example vendor tables 106, the example record database 108, and/or, more generally, the example ISP 100 of FIG. 1 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example ACMS 102, the example vendor tables 106, the example record database 108, and/or, more generally, the example ISP 100 of FIG. 1 are hereby expressly defined to include a tangible medium such as a memory, DVD, CD, etc. storing the software and/or firmware. Further still, the example ISP 100 of FIG. 1 may include one or more elements, processes and/or devices in addition to, or instead of, those illustrated in FIG. 1, and/or may include more than one of any or all of the illustrated elements, processes and devices.

Generally, the ISP 100 receives service orders from one or more entities that want and/or need to establish a connection to the network 101. The illustrated example of FIG. 1 includes a subscriber premises 112 as an example entity to be connected to the network 101 by the ISP 100. In the illustrated example of FIG. 1, the subscriber premises 112 is an office building. However, the ISP 100 may receive and process service orders from additional or alternative entities such as, for example, commercial establishments, different types of businesses, private residences, such as homes, apartments, etc., universities, individuals using portable communication devices such as personal digital assistants, cellular telephones, laptop computers, or any other entity that may want and/or need connectivity to the network 101.

In the illustrated example, the subscriber premises 112 is inhabited by an organization, such as a company having a plurality of employees, some or all of which are assigned a communication device. For purposes of clarity and brevity, the illustrated example of FIG. 1 shows the organization represented by a single subscriber 114. The example subscriber 114 may be, for example, an office administrator and/or information technology (IT) personnel in charge of establishing and/or maintaining connectivity between one or more communication devices 116 and the network 101. The example communication device 116 of FIG. 1 is a personal computer having network communication equipment, such as a cable or DSL modem, an Ethernet network interface card, a network adapter, a wireless network card, etc., installed thereon that is capable of transferring data to and from or otherwise communicating with one or more network devices such as, for example, switches, hubs, routers, and/or gateways that implement a data network such as, for example, a local area network (LAN), a wide area network (WAN), a metropolitan area network (MAN), a campus area network (CAN), etc. Example network connections between the subscriber premises 112 and the network 101 are described in greater detail below in connection with FIGS. 5A-C. In the illustrated example, because the subscriber premises 112 includes a plurality of communication devices 116 needing access to the network 101, the subscriber premises 112 typically includes additional network communication devices such as a router (not shown) capable of aggregating transmissions from the communication devices and routing the transmissions to and from a network.

To place a service order, the subscriber 114 contacts the ISP 100 by, for example, calling a service representative at the ISP 100, placing a service order in the mail, submitting an online application via a webpage implemented by the ISP 100, or any other suitable method of placing a service order. In response, the ISP 100 begins a process of placing the subscriber premises 112 in communication with a network device 118, which may be implemented and/or managed by the ISP 100. In the illustrated example of FIG. 1, the network device 118 is an Ethernet gateway switch (EGS). The EGS 118 is capable of placing the personal computer 116 in communication with other accessible communication devices connected to the network 101, such as web servers, databases, and/or any other resource of the network 101. To provide interoperability with such network resources, the EGS 118 is capable of interfacing with network devices of the network 101 that use different protocol(s) using one or more translation techniques. Once the personal computer 116 is placed in communication with the EGS 118, the subscriber 114 can access any number of network resources of the Internet via a series of routing instructions executed by the EGS 118 and other devices of the network 101.

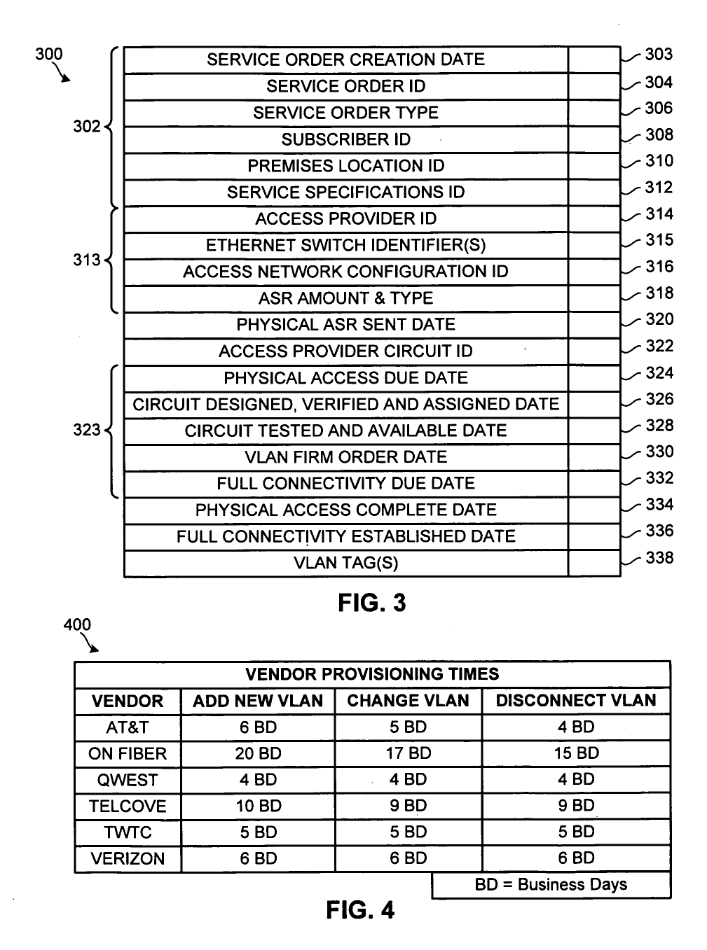

To begin the processing of the service order, the ACMS 102 creates an entry in the record database 108 and populates a plurality of fields with information related to the received service order. Throughout the pendency of the service order, the database entry is populated with new information and/or updated to reflect developments related to the service order. Generally, the fields of the database entry are used to populate one or more ASRs and to maintain a record of adjustable critical dates associated with the service order. FIG. 3 is an example entry 300 in the example record database of FIG. 1 corresponding to an example service order placed by the example subscriber 114 of FIG. 1. The example entry 300 and the associated critical dates are described below in connection with FIG. 3.

In the illustrated example of FIG. 1, the link between the personal computer 116 and the EGS 118 includes at least one intermediate connection to another network device. In some examples, a direct connection may be established between the subscriber premises 112 and the EGS 118 via, for example, a dedicated fiber, a private line, or another type of specialized transmission medium. However, in the illustrated example, the ISP 100 employs the services of at least one of a plurality of access providers 120a-d (also referred to herein as vendors) to provide an access network capable of linking the EGS 118 and the subscriber premises 112. In the example of FIG. 1, a first vendor 120a provides an example access network 122. The first vendor 120a has direct access and control over the infrastructure of the access network 122, which provides a transmission path between the subscriber premises 112 and other network devices including, for example, servers, switches, routers, gateways, etc., implementing some or all of the access network 122. The example access network 122 of FIG. 1 includes a plurality of central offices (COs) that are managed and operated by the first vendor 120a. The example of FIG. 1 shows a first CO 124a and a second CO 124b as part of the access network 122. However, the access network 122 may include additional COs dispersed over a geographic area in which the first vendors 120a operates.

In the illustrated example, the access network 122 is an Ethernet-based network implementing an Ethernet protocol which is capable of routing Ethernet frames from one communication device, such as the personal computer 116, to another communication device, such as the EGS 118. In other examples, the access network 122 may be the plain old telephone service (POTS), over which a digital subscriber line (DSL) service is implemented. In some examples, a DSL service can be implemented over the Ethernet-based access network 122.

The example first and second COs 124a and 124b of FIG. 1 communicate over the Ethernet-based access network 122 by transmitting a plurality of signals to and from a plurality of network devices, such as switches, routers, and/or gateways. The network devices at the first and second COs 124a and 124b are assigned identifiers by the first vendor 120a to enable recognition and/or configuration of individual network devices. In the illustrated example, the identifiers are assigned according to a geographic area serviced by the CO in which the corresponding network devices are implemented. The vendors 120a-d supply the ISP 100 with the identifiers that would be used to service certain geographic areas. In the example of FIG. 1, the ISP 100 stores the identifiers in association with their assigned geographic areas in the vendor tables 106. As described in greater detail below, the ACMS 102 and the components thereof reference the vendor tables 106 to determine which network device of which CO of the access network 122 will be used to service the subscriber premises 122 based on the geographic location of the subscriber premises 112. The corresponding identifier can then be used to create certain types of ASRs such as a physical ASR, which is described below.

In the illustrated example of FIG. 1, the first vendor 120a is a local exchange carrier (LEC), which provides access to a local loop implementing an Ethernet protocol over the access network 122. Such an LEC is sometimes referred to as an Ethernet local exchange carrier (ELEC). ELECs are sometimes used to provide services to metropolitan areas. A LEC typically manages a local access transport areas (LATA) covering one or more geographic areas.

In the example of FIG. 1, the first vendor 120a can physically and logically establish a connection 126 between network equipment at the subscriber premises 112, such as a router to which the personal computer 116 is coupled, and the access network 122. The example connection 126 between the subscriber premises 112 and the first CO 124a and, thus, the access network 122, is shown in the example of FIG. 1 as a dotted line to indicate that the connection 126 is to be made via the subscriber 114 placing a service order with the ISP 100.

The vendor 120a establishes the physical aspects of the connection 126 in response to a physical ASR conveyed by the ISP 100. For example, the first vendor 120a may establish such a connection by, for example, designing a circuit layout, connecting any necessary cables, fibers, and/or wires, installing any necessary equipment, providing the subscriber 114 a modem having capabilities associated with the protocol and/or service implemented over the access network 122, and/or provisioning one or more network devices included in the circuit designed for the subscriber premises 112. In the example of FIG. 1, such a process involves connecting equipment at the subscriber premises 112 to the first CO 124a and designating a circuit to place the subscriber premises 112, via one of more COs of the access network 122, in communication with the EGS 118. Once the vendor 120a designates and/or implements the connection circuit, the circuit is assigned an identifier (referred to herein as a circuit ID). A physical ASR may be an electronic message. It is not necessarily “physical”. It is referred to as “physical” because it addresses the physical layer of network connections.

The vendor 120a establishes the logical aspects of the connection 126 in response to a logical ASR, such as a virtual local area network (VLAN) ASR. As described in greater detail below, the circuit ID is needed on logical ASRs and, thus, must be obtained before logical ASRs can be created by the ISP 100. The logical aspects of the connection 126 include, for example, an assignment of the personal computer 116 to a certain VLAN. Generally, VLANs are logical groupings of communication devices that are segmented according to a policy other than or in addition to physical location. VLANs enable a logical topology to overlay the physical switched infrastructure such that communication devices can be, grouped, isolated, and/or combined according to a logical arrangement selected by, for example, the vendor 120a and/or the ISP 100. To route communications to and/or from VLANs, communication devices are assigned respective VLAN tags that are added to Ethernet frames as the communications travel across the communication system of FIG. 1. Thus, establishing the logical aspects of the connection may include the assignment of one or more VLAN tags to the personal computer 116.

To improve the efficiency of the creation and conveyance of the physical and logical ASRs, the example ISP 100 of FIG. 1 includes the ACMS 102. The example ACMS 102 is in communication with the vendor tables 106 and the record database 108. In response to receiving a service order from the subscriber 114, the ACMS 102 automatically coordinates the creation of the ASR(s) to be conveyed to the vendor 120a. As described herein, certain types of ASRs are interdependent and, thus, there is significant benefits from efficient coordination and execution of the ASR process.

The example ACMS 102 of FIG. 1 includes a vendor interface 128, a service order coordinator 130, and an ASR creator 132. The vendor interface 128 provides a means of communication between the ISP 100 and any one of the vendors 120a-d. Although the example vendor interface 128 is capable of exchanging information with any of the vendors 120a-d, for purposes of brevity, the example of FIG. 1 shows the ISP 100 communicating with the first vendor 120a. The example vendor interface 128 of FIG. 1 includes memory in which information, such as a plurality of ASRs, is stored or held for a period of time before being forwarded to the vendor 120a. Further, the vendor interface 128 receives information from the vendors 120a-d and, if necessary, forwards the same to the appropriate component of the ISP 100.

Generally, the example service order coordinator 130 increases the efficiency of the processing of a plurality of service orders to establish the connection 126 in an effective manner. ISPs typically include a plurality of branches, departments, teams, or units that separately handle different stages or steps involved in processing a service order. Further, many of the ASRs that are exchanged between the ISP 100 and the vendor 120a are interdependent. For example, a logical ASR typically cannot be created until certain information is received from the processing of a physical ASR that was previously conveyed to the vendor 120a. Therefore, in current systems, different branches or teams spend a significant amount of time and resources waiting for, inquiring into, and/or otherwise dealing with ASRs to be sent or received by other branches or teams. The example service order coordinator 130 of FIG. 1 provides a centralized entity capable of automatically coordinating the processing of a plurality of service orders and/or ASRs exchanged between the ISP 100 and the vendor 120a.

First, the example service order coordinator 130 is able to determine which of the vendors 120a-d is assigned to a certain service order and/or which of the vendors 120a-d is best suited to meet a particular service order. With the knowledge of which vendor 120a-d is selected to establish the connection 126, the example service order coordinator 130 of FIG. 1 is capable of determining what type of network connection will be established between the subscriber premises 112 and the EGS 118. That is, the service order coordinator 130 can determine a configuration of the access network 122. This determination is described in greater detail below in connection with FIGS. 5A-C, 6A and 6B.

Next, the service order coordinator 130 references the vendor tables 106 to determine one or more network device identifiers associated with the access network 122 that are to be used for the subscriber premises 112. The vendor tables 106 are populated with network device identifiers provided by the vendors 120a-d that correspond to network devices implemented at the COs 124a-b of the access network 122. The service order coordinator 130 uses a geographic location of the subscriber premises 112, which is provided on the service order by the subscriber 114, as an index into the vendor tables 106. When a proper identifier is determined, the example service order coordinator 130 of FIG. 1 populates a corresponding field of an entry in the record database 108 associated with the service order with the determined identifier. The identifier can be used to create a physical ASR requesting the vendor 120a to establish a physical aspect of the connection 126.

Further, the service order coordinator 130 references the vendor tables 106 to determine one or more critical dates specific to the selected vendor 120a. The example vendor tables 106 include critical date information related to the service(s) provided by the vendors 120a-d. The critical date information is used by the service order coordinator 130 to coordinate the creation, conveyance, and completion of ASRs. For example, each vendor 120a-d may provide the ISP 100 an estimated duration needed to fulfill a physical ASR for a subscriber located in a certain geographic location, an estimated duration of a configuration process or task associated with a connection of a certain type, and/or any other estimations of time needed to complete a task or service. The critical date information varies from vendor to vendor depending on, for example, geographic location and/or the capabilities of the vendor. Other example factors, such as service type, access network configuration, and/or bandwidth requirements, may affect the duration of time needed to fulfill an ASR. Because the critical date information is set using adjustable tables, new vendors may be conveniently supported by the ISP 100 and the ACMS 102 via an additional entry into the vendor tables 106.

In the illustrated example of FIG. 1, the critical date information of the vendor tables 106 is initially set according to data provided to the ISP 100 by the vendors 120a-d. In some examples, the ISP 100 may adjust the critical date information of the vendor tables 106 based on, for example, differences encountered in dealing with the vendors 120a-d between the estimated time durations provided by the vendors 120a-d and the actual time used to complete a given task or service.

The example service order coordinator 130 of FIG. 1 uses the critical dates to populate the critical date fields of an entry in the record database 108 associated with the service order. Throughout the lifetime of the service order, the service order coordinator 130 updates the database entries to reflect developments in the service order such as when a physical ASR is placed and/or fulfilled, when a logical ASR is scheduled and/or fulfilled, when the subscriber 114 may fully utilize the connection 126, etc. The example service order coordinator 130 of FIG. 1 is also capable of adjusting the critical dates in response to delays, unexpected problems, or any other type of development.

Using the critical date information associated with the service order, along with information received from the vendor 120a, the example service order coordinator 130 of FIG. 1 monitors the progress of the plurality of connectivity stages and/or tasks described herein and, in response to determining that the a certain stage or task has been completed or is at a certain point of processing, triggers the next action to continue the processing of the service order. For example, in response to receiving a confirmation that a physical aspect of the connection 126, such as a circuit identification number (ID), has been established, the service order coordinator 130 may automatically complete, generate, and/or forward a logical ASR.

Further, the example service order coordinator 130 detects whether the processing of a service order is in jeopardy of missing a deadline, an estimated connectivity completion date, and/or any other critical date. In such instances, the example service order coordinator 130 sends a notification of the possible delay to the subscriber 114 and/or the vendor 120a. On the other hand, when the processing of a service order has progressed as expected, the example service order coordinator 130 sends a notification of the likely completion date and/or any updates to the likely completion date to the subscriber 114 indicating that the ordered connectivity will be established on a certain date and time.

Generally, the example ASR creator 132 is capable of automatically combining information related to the subscriber 114 and/or the subscriber premises 112 with information related to the selected vendor 120a and/or the ISP 100 to create one or more ASRs. The information related to the subscriber 114 and/or the subscriber premises 112 can be obtained directly from the subscriber 114 and/or from an internal and/or external database containing information about existing subscribers and/or general members of the public. The example ASR creator 132 of FIG. 1 obtains information related to the vendor 120a from the vendor tables 106. The vendor tables 106 include database(s) and/or lookup tables storing information, such as equipment identifiers, circuit identifiers, critical dates, specialized instructions, and/or any other information necessary to complete an ASR, in association with the vendors 120a-d.

Using the collected information, the example ASR creator 132 creates one or more ASRs to be conveyed to the vendor 120a. The ASRs include information to direct the vendor 120a in performing the tasks necessary to establish the physical and/or logical aspects of the connection 126. For example, a physical ASR includes a network device identifier dedicated to servicing a geographic area including the subscriber premises 112. As described herein, network device identifiers and the associated geographic areas are stored in the vendor tables 106. Additionally, the physical ASR may include information related to a type of service requested, one or more equipment specifications and/or requirements, and/or any other information needed to establish the physical aspects, components, and/or settings of the connection 126. In another example, a logical ASR includes a circuit ID assigned to a connection 133 between the EGS and the second CO 124b and/or the connection 126 between the subscriber premises 112 and the first CO 124a, as selected by the vendor 120a in response to the previously conveyed physical ASR. As described herein, the circuit ID is not known to the ISP 100 and, therefore, cannot be used on the logical ASR, until information is returned to the ISP 100 from the vendor 120a in response to the physical ASR.

The ASRs are conveyed to the vendor 120a via the vendor interface 128 as instructed by the service order coordinator 130. The ASRs are received by the vendor 120a via an order processing unit 134. The order processing unit 134 includes device(s) and/or personnel capable of receiving an ASR, determining if the ASR includes the information needed to properly fulfill the ASR, and directing the responsible unit(s) and/or device(s) to perform the tasks necessary to fulfill the ASR.

In the illustrated example of FIG. 1, to fulfill the one or more ASRs received from the ISP 100, the vendor 120a includes a network configuration controller 136 and a virtual local area network (VLAN) manager 138. The example network configuration controller 136 receives physical ASRs and/or logical ASRs, such as VLAN ASRs, and provisions resources to perform the tasks necessary to meet the received ASRs. As described above, the vendor 120a manages and controls the access network 122 and the network components thereof. To establish the connection 126 between the subscriber premises 112 and the access network 122, the network components managed and controlled by the vendor 120a are configured and/or set to recognize, receive, and/or otherwise communicate with the communication device 116 at the subscriber premises 112. For example, to meet a physical ASR received from the ISP 100, the network configuration controller 136 selects a circuit to establish the connection 126 and assigns a circuit ID thereto. To select the circuit for the connection 126, the vendor 120a uses information from the physical ASR such as, for example, bandwidth requirements, a type of network service to be delivered to the subscriber premises 116, and/or a service to be provided, such as a new connection, a disconnection, or a change of connection settings. The selected circuit ID may be in a range of circuit IDs available for connections in the geographic location of the subscriber premises 112.

Additionally, the network configuration controller 136 dedicates resources and/or instructs one or more entities to complete the physical aspects of the connection 126. For example, if necessary, cables, optical fibers, wires, and/or other types of transmission mediums are laid between the first CO 124a and the subscriber premises 112. Further, the network configuration controller 136 may direct one or more entities to provide the subscriber 114 with, for example, a modem configured to communicate with the access network 122, such as DSL modem.

When a physical ASR has been processed and the physical aspects of the connection 126 have been established and/or selected, the example network configuration controller 136 informs the order processing unit 134. In response, the example order processing unit 134 conveys a Firm Order Commit (FOC) to the ISP 100 including information about the physical connection that has been or will be established, such as the circuit ID assigned to the connection 126 and an estimated date of completion.

In response to a VLAN request, the vendor 120a configures the logical aspects of the connection 126, such as an assignment of the communication device 116 to a specific VLAN. Generally, the VLAN manager 136 administers a plurality of VLANs 140a-c, each of which includes a plurality of communication devices assigned thereto having access to the network 101. In the illustrated example of FIG. 1, a first VLAN 140a (labeled as VLAN X) and a second VLAN 140b (labeled as VLAN Y) have access to the EGS 118 via the access network 122. Further, the example of FIG. 1 includes a third VLAN 140c (labeled as VLAN Z) having direct access to the EGS 118, without the services of the access network 122. In other examples, VLANs may have additional or alternative routes of communication with the network 101 and/or any other data network.

As described above, VLANs are logical groupings of communication devices that are segmented according to a policy other than or in addition to physical location. For example, in some VLANs, communication devices are grouped based on an organizational status, such as a departmental assignment, a team membership, or a job title. To route communications to and from the VLANs 140a-c, communication devices are assigned VLAN tags that are added to Ethernet frames as the communications travel across the communication system of FIG. 1. For example, when an Ethernet frame leaves one of the communication devices of the first VLAN 140a, the Ethernet frame is populated with a VLAN tag associated with that communication device. That is, the VLAN tag indicates a source of the Ethernet frame. Depending on the configuration of the access network 122, the VLAN tags may be altered by one or more network devices, such as switches located in the access network 122 and/or the EGS 118. In some examples, additional VLAN tags are added to the Ethernet frame by network devices to indicate which access network, such as the access network 122 of FIG. 1, the Ethernet frame traveled across. While the administration of the VLANs 140a-c can be complex, for purposes of this discussion, the VLAN tags are described generally as identifiers that indicate a source for an Ethernet frame, a destination for an Ethernet frame, and/or one or more routing devices via which an Ethernet frame travels.

The VLAN manager 138 includes a VLAN assignor 142 and a VLAN database 144. The VLAN assignor 142 includes a plurality of rules that dictate to which VLAN the communication device 116 will be assigned. In the illustrated example, the VLAN assignor 142 assigns the communication device 116 to a VLAN, such as the first VLAN 140a, by creating an entry in the VLAN database 144 corresponding to the communication device 116 and associating a VLAN identifier, such as a color representing one of the VLANs 140a-c, with the created entry in the VLAN database 144. To enable the communication device 116 to communicate over the network 101 and/or the access network 122 as part of the VLAN to which the communication device 116 is assigned, the VLAN assignor 142 assigns a VLAN tag that the communication device 116 uses in sending Ethernet frames. In the illustrated example, such an assignment includes configuring a modem or other type of network device through which the subscriber premises 112 is coupled to the access network 122 to add the assigned VLAN tag to any Ethernet frames originating at the communication device 116. As described above, VLAN tags identify a destination, a source, and/or one or more intermediate network devices via which the corresponding Ethernet frame has traveled. Thus, the VLAN manager 138 enables the communication device 116 to send and receive communications as part of a VLAN controlled by the vendor 120a.

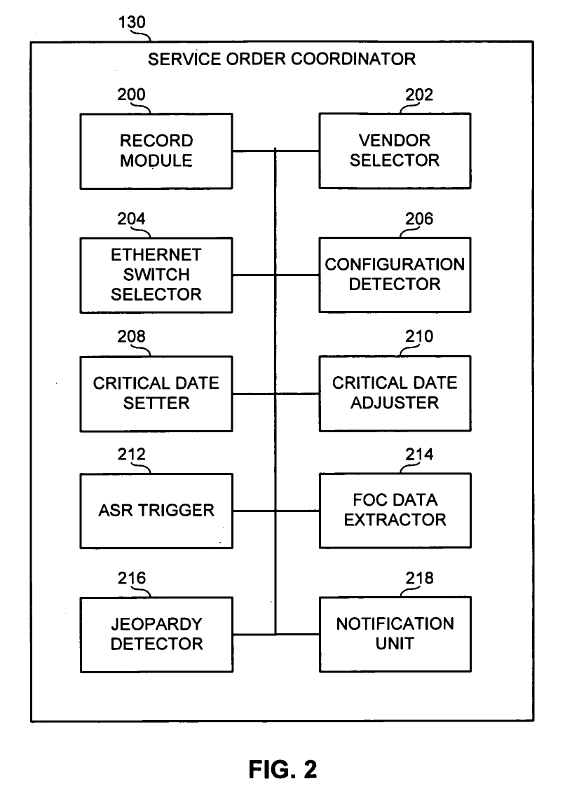

FIG. 2 is a block diagram of an example apparatus that may be used to implement the example service order coordinator 130 of FIG. 1. In the illustrated example of FIG. 2, the example service order coordinator 130 includes a record module 200, a vendor selector 202, a Ethernet switch selector 204, a configuration detector 206, a critical date setter 208, a critical date adjuster 210, an ASR conveyance trigger 212, an FOC data extractor 214, a jeopardy detector 216, and a notification unit 218. While an example manner of implementing the service order coordinator 130 of FIG. 1 has been illustrated in FIG. 2, one or more of the elements, processes and/or devices illustrated in FIG. 2 may be combined, divided, re-arranged, omitted, eliminated and/or implemented in any other way. Further, the example record module 200, the example vendor selector 202, the example Ethernet switch selector 204, the example configuration detector 206, the example critical date setter 208, the example critical date adjuster 210, the example ASR conveyance trigger 212, the example FOC data extractor 214, the example jeopardy detector 216, and the example notification unit 218, and/or, more generally, the example service order coordinator 130 of FIG. 2 may be implemented by hardware, software, firmware and/or any combination of hardware, software and/or firmware. Thus, for example, any of the example record module 200, the example vendor selector 202, the example Ethernet switch selector 204, the example configuration detector 206, the example critical date setter 208, the example critical date adjuster 210, the example ASR conveyance trigger 212, the example FOC data extractor 214, the example jeopardy detector 216, and the example notification unit 218, and/or, more generally, the example service order coordinator 130 of FIG. 2 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example record module 200, the example vendor selector 202, the example Ethernet switch selector 204, the example configuration detector 206, the example critical date setter 208, the example critical date adjuster 210, the example ASR conveyance trigger 212, the example FOC data extractor 214, the example jeopardy detector 216, and the example notification unit 218, and/or, more generally, the example service order coordinator 130 of FIG. 2 are hereby expressly defined to include a tangible medium such as a memory, DVD, CD, etc. storing the software and/or firmware. Further still, the example service order coordinator 130 of FIG. 2 may include one or more elements, processes and/or devices in addition to, or instead of, those illustrated in FIG. 2, and/or may include more than one of any or all of the illustrated elements, processes and devices.

The example service order coordinator 130 of FIG. 2 is described below in connection with the example database entry 300 of FIG. 3. The database entry 300 of FIG. 3 includes a plurality of fields to be populated over the pendency of the service order placed by the subscriber 114. The database entry 300 can be referenced by, for example, the ASR creator 132 when populating a standard ASR form with information related to the service order, such as a network device identifier associated with the first CO 124a of FIG. 1, a circuit ID associated with the connections 126 and/or 133 of FIG. 1, one or more critical dates, information associated with the subscriber premises 112, and/or any data to be entered on a standardized ASR. Additionally or alternatively, the database entry 300 can be referenced by, for example, the service order coordinator 130 in creating, scheduling, and/or causing the conveyance of different types of ASRs to the vendor 120a.

In the illustrated example, the record module 200, which is in communication with all of the other elements, processes, and/or devices of the example service order coordinator 130 of FIG. 2, creates and updates the fields of the entry 300. However, the fields of the entry 300 can be populated by any of the elements, processes and/or devices of the example service order coordinator 130 of FIG. 2 including, for example, the example record module 200, the example vendor selector 202, the example Ethernet switch selector 204, the example configuration detector 206, the example critical date setter 208, the example critical date adjuster 210, the example ASR conveyance trigger 212, the example FOC receiver 214, the example FOC data extractor 216, the example jeopardy detector 218, and the example notification unit 220. Additionally or alternatively, the fields of the database entry 300 may be populated by other suitable elements, processes, and/or devices such as, for example, the vendor interface 128, the ASR creator 132, and/or the ACMS 102 of FIG. 1.

Initially, the record module 200 uses information received from the subscriber 114 via the service order to populate a set of subscriber-related fields 302. In the illustrated example, the subscriber-related fields 302 include a service order creation date 303, which indicates a date on which the service order is created or released by the ACMS 102 for processing; a service order identifier 304, such as a universal service order (USO)); a service order type identifier 306, which indicates whether the service order is association with a new connection, a disconnect order, a connection configuration change order, or any other type of service order; a subscriber identifier 308, such as an alphanumeric tag that is unique to the subscriber 114; a subscriber premises location identifier 310, such as an address or other type geographic location of the subscriber premises 112; and a service specifications identifier 312, such as a code corresponding to a type of service ordered by the subscriber 114. In the illustrated example, each of the subscriber-related fields 302 can be populated using information that is required to be submitted with the service order by the ISP 100.

Further, vendor selector 202, the Ethernet switch selector 204, and the configuration detector 206 determine information regarding the access network 122 and at least one of the vendors 120a-d to populate a set of access network related fields 313. In particular, the example vendor selector 202 of FIG. 2 selects one of the vendors 120a-d to fulfill a service order received from the subscriber 114. The example vendor selector 202 takes a plurality of factors into account in determining which of the vendors 120a-d is best suited to establish connectivity between the subscriber premises 112 and the EGS 118. For example, upon receiving information regarding the geographic location of the subscriber premises 112, the example vendor selector 202 can select one of the vendors 120a-d based on which of the vendors 120a-d manages a LATA and/or LAN including the subscriber premises 112. In other examples, the selection of one of the vendors 120a-d may be based on other factors, such as a contracted or negotiated term, subscribed service requirements such as transmission speed and/or bandwidth, or any other suitable factor. In some instances, only one of the vendors 120a-d is capable of establishing connectivity between the subscriber premises 112 and the EGS 118. If so, the vendor selector 202 assigns that vendor 120a-d to the corresponding service order. In the illustrated example, the vendor selector 202 assigns the first vendor 120a to the service order. In response, the record module 200 populates an access provider identifier 314 of the entry 300 with data corresponding to the first vendor 120a, such as a code or common language name.

The example Ethernet switch selector 204 references the vendor tables 106 to determine a network device identifier assigned to the geographic area in which the subscriber premises 112 is located. As described above, the vendor 120a supplies the ISP 100 with information regarding which CO and, thus, which network device is configured to service connections originating from certain geographic areas. The example ISP 100 of FIG. 1 stores the information in the vendor tables 106. In the illustrated example of FIG. 1, the access network 122 is an Ethernet-based communication network including Ethernet switch network devices. Thus, the example service order coordinator 130 of FIG. 2 includes the Ethernet switch selector 204. The example Ethernet switch selector 204 uses the geographic location information stored as the premises location identifier 310 along with the access provider identifier 314 of the database entry 300 as indices for a query into the vendor tables 106. The query returns the appropriate network device identifier and the Ethernet switch selector stores the returned information as an Ethernet switch identifier 315 in the database entry 300.

The example configuration detector 206 detects one or more configurations and/or settings of the access network 122. In particular, the configuration detector 206 references the access provider identifier 314 to determine which of the vendors 120a-d and, therefore, which access network will be utilized to connect the subscriber premises 112 to the EGS 118. Further, the configuration detector 206 references the service specifications identifier 312 to determine what type of network service will be provided to the subscriber 114. For example, the ISP 100 may provide services including digital private line access, a frame relay service, asynchronous transfer mode (ATM) access, a virtual private network (VPN), or managed Internet service (MIS) Ethernet access, such as the MIS Ethernet access provided by AT&T®. For purposes of illustration, the service provided to the subscriber premises 112 in the example of FIG. 1 is MIS Ethernet access.

When the type of service to be provided is determined, the configuration detector 206 then determines a configuration of the access network 122 and stores a code corresponding to the detected configuration in an access network configuration identifier 316 of the database entry 300. The configuration of the access network 122 enables the example service order coordinator 130 to determine what type of and how many ASRs are to be created and conveyed to the vendor 120a. In particular, different access network configurations have differing numbers of connections between network devices and, thus, require different numbers and/or types of ASRs. For example, in instances in which more than one physical ASRs is necessary to establish connectivity, a first physical ASR may include a first pair of endpoints to be connected, such as the subscriber premises 112 and the first CO 124a, and a second physical ASR may include a second pair of endpoints to be connected, such as the second CO 124b and the EGS 118.

After the configuration detector 206 determines the appropriate type(s) and amount(s) of ASRs for the service order, the record module 200 populates an ASR amount and type field 318 with such information. For purposes of illustrating how different access network configurations may cause different types and amounts of ASRs to be necessary to establish network connectivity, FIGS. 5A-C, which are described in detail below, are schematic illustrations of example access network configurations that can be supported by the example ISP of FIG. 1.

In the illustrated example, when the information described above is determined and stored in the database entry 300, a physical ASR can be created and conveyed to the vendor 120a. To cause the creation and conveyance of the physical ASR, the ASR trigger 212 directs the ASR creator 132 to create a physical ASR by populating the required fields thereof using, for example, the subscriber-related fields 302, the access provider identifier 314, the Ethernet switch identifier 315, and the access network configuration identifier 316. When the physical ASR has been conveyed to the vendor 120a, the ASR trigger 212 populates a physical ASR sent date 320 in the example database entry 300.

In response to the physical ASR, the ISP 100 is to receive a Firm Order Commit (FOC) from the vendor 120a. The FOC indicates that the vendor 120a has committed to fulfilling the physical ASR and includes the circuit ID that has been assigned to the circuit designed by the vendor 120a to establish the connectivity to the subscriber premises 112. As described herein, the circuit ID is needed to create a logical ASR, such as the VLAN ASR described below. Therefore, when the vendor 120a conveys the FOC to the ISP 100, the FOC data extractor 214 extracts the circuit ID listed therein and populates an access provider circuit ID field 322 in the database entry 300.

The example critical date setter 208 of FIG. 2 uses the access provider identifier 314, service order type field 306, and the vendor tables 106 to populate an example set of critical date fields 323 of the database entry 300. As an illustration of how the critical date setter 208 enables the service order coordinator 130 to optimize the processing of the service order, the critical date setter 208 of FIG. 1 schedules the processing of a VLAN ASR based on estimated dates of completion associated with a physical ASR. Some example service orders, such as changes of connection settings, require only a VLAN ASR. Conversely, as described above, some example service orders, such as new connection requests or disconnection requests, require a physical ASR and a VLAN ASR. The type of service request can be determined by reference to the service order type identifier 306, which is populated by the record module 200 using subscriber-provided information. In instances in which a physical and logical ASR are needed, the ASR creator 132 needs information from the vendor 120a to populate the logical ASR with the required information. In the illustrated example, the ASR creator 132 needs the circuit ID associated with the physical circuit designed by the vendor 120a in response to a previously conveyed physical ASR. In other words, the VLAN ASR and the processing thereof are dependent on the processing of the physical ASR by the vendor 120a. Generally, the example critical date setter 208 of FIG. 2 uses the vendor tables 106 to set the critical dates 323 of the database entry 300 such that dependent VLAN ASRs are scheduled, created, and conveyed to the vendor 120a as efficiently as possible.

The example set of critical date fields 323 of the FIG. 3 includes a physical access due date 324, which indicates a date on which the ISP 100 expects the vendor 120a to fulfill a physical ASR; a circuit selected, verified, and assigned (DVA) date 326, which indicates a date on which a circuit has been selected and/or that an order to do so has been created; a circuit tested and available (CTA) date 328, which indicates a date on which the ISP 100 is to confirm the completion of the connection by testing the connectivity of the connection 126; a VLAN firm order date (FOD) 330, which indicates a scheduled date on which the VLAN ASR is to be conveyed to the vendor 120a; and a full connectivity due date 332, which indicates an expected date on which network access will be fully available to the subscriber 114.

The critical date setter 208 obtains the physical access due date 324 directly from the vendor tables 106, which stores an agreed upon period of time for the vendor 120a to fulfill a physical ASR. The critical date setter 208 adds the agreed upon duration to the date at which the physical ASR was conveyed to the vendor 120a and stores the resulting date as the physical access due date 324. The critical date setter 208 of FIG. 2 then uses the physical access due date 324 as a reference date to set other critical dates 323. In particular, the example critical date setter 208 of FIG. 2 is configured to set the DVA date 326, the CTA date 328, and the VLAN FOD 330 based on offsets that may or may not vary depending on which one of the vendors 120a-d is fulfilling the service order.

In the illustrated example, if the service order requires both a physical ASR and a logical ASR, the critical date setter 208 is configured to set the DVA date 326 and the CTA date 328 according to fixed offsets. In particular, the example critical date setter 208 of FIG. 2 is configured to set the DVA date 326 to the physical access due date 324 less two business days. The example critical date setter 208 of FIG. 2 is configured to set the CTA date 328 to the physical access due date 324 less six business days.

Further, in the illustrated example, if the service order requires both a physical ASR and a logical ASR, the critical date setter 208 is configured to set the VLAN FOD 330 according to an equation incorporating a vendor provisioning time (VPT) variable. In the illustrated example, the equation is:

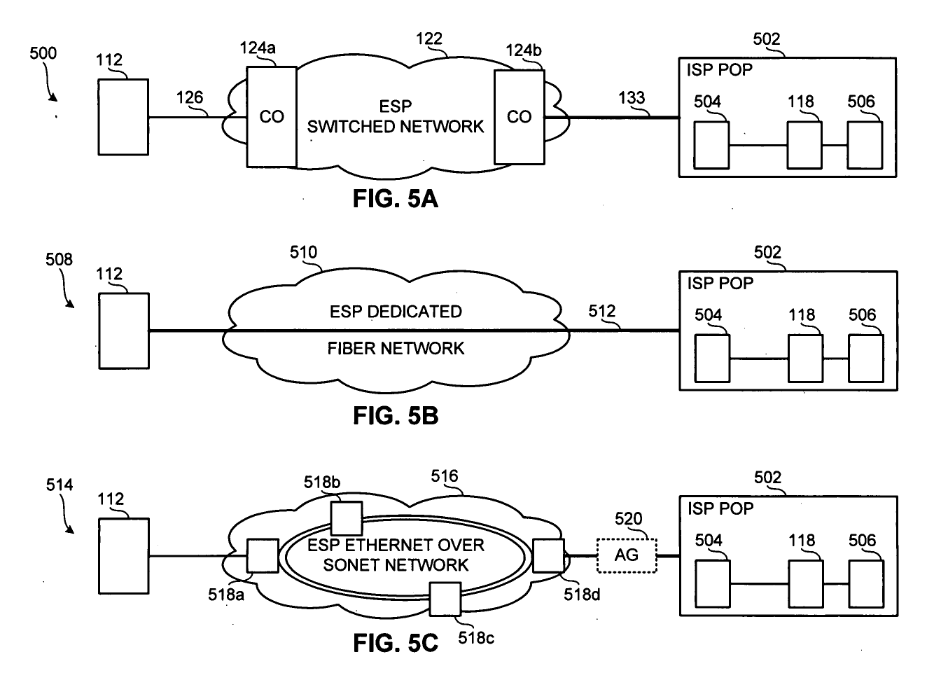

VLAN FOD=(physical access due date)−(5 business days+VPT),

where the VPT is a value stored in the vendor tables 106 corresponding to an estimated period of time provided by each vendor 120a-d. FIG. 4 is an example vendor provisioning time table 400 stored in the example vendor tables 106 of FIG. 1. As shown in the example table 400 of FIG. 4, the VPTs may vary from vendor to vendor and depend on a type of service order being processed. Further, while the vendors 120a-d provide the ISP 100 with initial values for the VPT table 400, the ISP 100 may alter the VPT values according to past transactions that did not conform to the initial VPTs.

As described above, service orders may require the creation and conveyance of a logical ASR, such as a VLAN ASR, without requiring a physical ASR. In such instances, the critical date setter 208 is configured to set the VLAN FOD 330 according to a fixed offset. In particular, the example critical date setter 208 of FIG. 2 is configured to set the VLAN FOD 330 to the service order creation date 303 plus one business day.

Further, in the illustrated example, if the service order requires only a logical ASR, the critical date setter 208 is configured to set the DVA date 326 and the CTA date 328 according to equations incorporating a vendor provisioning time (VPT) variable. In the illustrated example, the equations are:

DVA=VLAN FOD+1 business day+VPT, and

CTA=DVA+4 business days,

where the value of VPT is determined from the example table 400 of FIG. 4.

The example critical date setter 208 determines the full connectivity due date 332 based on, for example, the service order type 306, the ASR amount and type field 318, and/or the access network configuration identifier 316. For example, for a VLAN ASR that is independent of a physical ASR, the example critical date setter 208 of FIG. 2 sets the full connectivity date 332 according to the following equation:

Full connectivity date=service order creation date+9 business days+VPT,

where VPT is a date found in the example table 400 of FIG. 4 based on the type of service order and the identified vendor. In other examples, the full connectivity date 332 is set according to a customer requested due date.

Further, the example database entry 300 of FIG. 3 includes a physical access complete date 334, which indicates a date on which the vendor 120a fulfills a physical ASR. The critical date setter 208 or the record module 200 sets the physical access complete date 334 in response to receiving an indication from the vendor 120a that the physical aspects of the connection 126 are complete. Further, the example database entry 300 of FIG. 3 includes a full connectivity established date 336, which indicates when the ISP 100 can inform the subscriber 114 that network access has been established and that network access is available.

In the event that any of the critical dates 323 and/or any other estimated due dates are not met by the vendor 120a and/or the ISP 100, or if any tasks are completed earlier than estimated, the example critical date adjuster 210 alters the contents of one or more appropriate fields of the database entry 300. For example, in response to determining that an FOC for a physical ASR has not been received by an expected date, the example critical date adjuster 210 may extend the physical access due date 324 and/or the VLAN FOD 330 to a later date than as originally set by the critical date setter 208.

If the example jeopardy detector 216 of FIG. 2 determines that the full connectivity due date 332 may be missed based on a current date and work yet to be completed, the jeopardy detector 216 of the illustrated example causes the notification unit 218 to send a notice to the vendor 120a and/or the subscriber 114 that connectivity may be delayed. The notification unit 218 is capable of communicating with the subscriber 114 and the vendors 120a-d via any suitable method, such as an automated email or telephone call. In some examples, the notice may prompt the responsible entity of the ISP 100 to contact the vendor 120a to inquire into the status of a pending ASR.

Further, the example database entry 300 of FIG. 3 includes a VLAN tag(s) field 338. As described above, in response to a VLAN ASR, the vendor 120a assigns the communication device 116 at the subscriber premises 112 one or more VLAN tags to enable communication over the access network 122. In particular, the VLAN tag(s) are to be added to Ethernet packets generated by the communication device 116 and can be used by other network devices to route communications to and from the communication device 116. Upon receiving the VLAN tag(s) from the vendor 120a, the vendor interface 128 forwards the VLAN tag(s) to the record module 200. In the illustrated example, the record module 200 populates the VLAN tag(s) field 338 of the database entry 300 with the VLAN tag(s) received from the vendor interface 128.

While example configurations of the critical date setter 208 and the vendor tables 106 are described above, the offsets, the VPT table 400, the database entry 300 and the components thereof, the equations, and/or the values of these examples are meant for illustrative purposes. Additional or alternative offsets, tables, database entries, critical dates, equations, VPT values, and/or configurations can be used for the example methods, apparatus, systems, and/or articles of manufacture described herein.

FIGS. 5A-C are schematic illustrations of example access network configurations that can be supported by the example ISP of FIG. 1. While three example access network configurations are shown in FIGS. 5A-C for purposes of illustration, other network configurations are possible and may be supported by the example methods, apparatus, systems, and/or articles of manufacture described herein. The configuration 500 of FIG. 5A is substantially similar to the access network configuration illustrated in FIG. 1. In particular, equipment at the subscriber premises 112 (sometimes referred to as customer premises equipment (CPE)) is coupled to equipment located at the first CO 124a. The first CO 124a is in communication with the second CO 124b via an Ethernet switched network 122. The Ethernet switched network 122 is capable of transporting data according to a plurality of values stored in the corresponding Ethernet frames such as, for example, a destination address, a source address, one or more VLAN tags, etc. The second CO 124b is coupled to a point-of-presence (POP) 502 of the ISP 100. The connection 133 between the second CO 124b and the POP 502 is a 1000BLX transmission medium that a plurality of subscribers share. In other words, the transmission medium associated with the connection 133 is capable of handling a large amount of data originating from a large amount of sources and delivering the same to and from the POP 502. Preferably, this connection 133 is established by the ISP 100 prior to the processing of the current service order and is used for a plurality of service orders.

The POP 502 includes an interface 504, an EGS, such as the EGS 118 of FIG. 1, and a Gigabit switch router 506. The interface 504 receives communications from the second CO 124b and/or other COs implemented over the access network 122 and forwards the same to the EGS 118. In some examples, the interface 504 translates certain portions of the data before conveyance to the EGS 118. The EGS 118 is coupled to the network 101 of FIG. 1 via the Gigabit switch router 506. As described above, the EGS 118 is capable of interfacing with network devices of the network 101 that use different protocol(s) to provide interoperability to the POP 502. The switch router 506 implements routing instructions configured to direct data communications between the EGS 118 and any of the network resources located across the network 101 such as, for example, web servers implementing one or more web pages. Generally, the POP 502 of FIG. 5A and the components thereof operate in a similar manner as the POPs of FIGS. 5B and 5C, which are also labeled with reference numeral 502.

In the illustrated example, the detection of the configuration 500 of FIG. 5A by the configuration detector 206 causes the record module 200 to populate the access network configuration identifier 316 of FIG. 3 with a code corresponding to an Ethernet switched access network. The example configuration detector 206 is also capable of determining what type and how many ASRs are to be conveyed to the vendor 120a based on the value of the access network configuration identifier 316 and/or the access provider identifier 314. For example, if the configuration 500 of FIG. 5A is detected, two physical ASRs and one VLAN ASR are to be conveyed to the vendor 120a. In particular, a first physical ASR for endpoints corresponding to the subscriber premises equipment and the first CO 124a is to be conveyed to the vendor 120a. Further, a second physical ASR for endpoints corresponding to the second CO 124b and the POP 502 is to be conveyed to the vendor 120a. However, the connection 133 between the second CO 124b and the POP 502 (or the EGS 118) is preferably already established at the time the service order is received from the subscriber 114. Therefore, in most instances, the second physical access request ASR is obviated due to the existing connection that is likely to have already been established. The record database 108 stores one or more entries indicating whether the connection 133 and/or other connections have already been established, thereby obviating the need for the second physical ASR in the event that the configuration 500 of FIG. 5A is detected.

In other examples, the Ethernet switched access network 122 of FIG. 5A may include an aggregator, such as a multiplexing device used to combine and select between a plurality of communication lines. In such instances, only one physical ASR is to be conveyed to the vendor 120a, such as an ASR for endpoints corresponding to the subscriber premises 112 and the first CO 124a. A physical ASR for the connection between the aggregator and the POP 502 is typically obviated because that connection is likely to have already been established.

The example configuration 500 of FIG. 5A causes one VLAN ASR to be conveyed to the vendor 120a to obtain the necessary VLAN tags and/or other aspects needed to establish the logical connection between the EGS 118 and the subscriber premises 112.

In the configuration 508 of FIG. 5B, an access network 510 is configured to implement a dedicated fiber network. In such a configuration, no switching and/or routing between COs is necessary as the subscriber premises 112 is connected directly to the POP 502. That is, the subscriber 114 does not share a connection with other subscribers in the dedicated fiber network. A transmission medium 512, such as an optical fiber or other type of high-speed medium, couples the subscriber premises 112 to the POP 502.

The detection of the configuration 508 of FIG. 5B by the configuration detector 206 causes the record module 200 to populate the access network configuration identifier 316 with a code corresponding to a dedicated fiber network. In the illustrated example, if the configuration 508 of FIG. 5B is detected, one physical ASR is to be conveyed to the vendor 120a. In particular, the physical ASR has endpoints corresponding to the subscriber premises equipment and the first POP (or the EGS 118) is to be conveyed to the vendor 120a. Further, if the configuration 508 of FIG. 5B is detected, no VLAN ASR is conveyed to the vendor 120a. No VLAN ASR is conveyed to the vendor 120a because the cooperation of the vendor 120a is not necessary to establish a logical connection between the POP 502 and the subscriber premises 112.

In the configuration 514 of FIG. 5C, an access network 516 is configured to implement Ethernet over a synchronous optical networking (SONET) network. SONET is a physical layer protocol similar to the packet-oriented transmission utilized in the Ethernet network of FIG. 5A. However, the configuration of SONET packets and the ordering of the transmission thereof varies from that of an Ethernet switched network to enable synchronization across the network 516. SONET networks may be configured in a plurality of architectures such as, for example, linear automatic protection switching (APS), unidirectional path switched ring (UPSR), or bidirectional line switched ring (BLSR). In the illustrated example, the SONET network includes a plurality of network elements, such as COs, having add-drop multiplexing (ADM) devices 518a-d implemented therein. The ADM devices 518a-d enable communication between the COs and effectively place the subscriber premises 112 in communication with the POP 502.

The detection of the configuration 514 of FIG. 5C by the configuration detector 206 causes the record module 200 to populate the access network configuration identifier 314 with a code corresponding to an Ethernet over SONET network. In the illustrated example, if the configuration 514 of FIG. 5C is detected, the configuration detector 206 then determines whether an aggregator 520 is present in the SONET network 516. If an aggregator 520 is present, two physical ASRs are to be conveyed to the vendor 120a. In particular, a first physical ASR for endpoints corresponding to the subscriber premises equipment at the subscriber premises 112 and the aggregator 520 is to be conveyed to the vendor 120a. Further, a second physical ASR for endpoints corresponding to the aggregator 520 and the POP 502 is to be conveyed to the vendor 120a. However, as described above, a connection between the aggregator 520 and the POP 502 (or the EGS 118) is preferably already present at the time the service order is received from the subscriber 114. Therefore, in most instances, the second physical access request ASR is obviated due to that existing connection. The record database 108 stores one or more entries indicating whether the connection to the POP 502 from the aggregator 520, and/or other connections, have already been established, thereby obviating the need for the second physical access request ASR.

In other examples, when the SONET network 516 of FIG. 5C includes the aggregator 520, only one physical ASR is to be conveyed to the vendor 120a, namely the physical ASR for endpoints corresponding to the subscriber premises 112 and the aggregator 520.

As mentioned above, the example configuration 514 of FIG. 5C causes one VLAN ASR to be conveyed to the vendor 120a to obtain the necessary VLAN tags and/or other aspects needed to establish the logical connection between the EGS 118 and the subscriber premises 112.

While example types and amounts of ASRs are described in connection with the example configurations 500, 508, and 514 of FIGS. 5A-C, different types and/or different amounts of ASRs may be created, conveyed, and/or assigned in such configurations and/or alternative configurations. Additionally or alternatively, the endpoints of the described example ASRs may differ according to different configurations and/or network equipment used to implement the access network 122 of FIG. 1. As described above, after the configuration detector 206 determines the appropriate type(s) and amount(s) of ASRs for the service order, the record module 200 populates an ASR amount and type field 316 with such information.

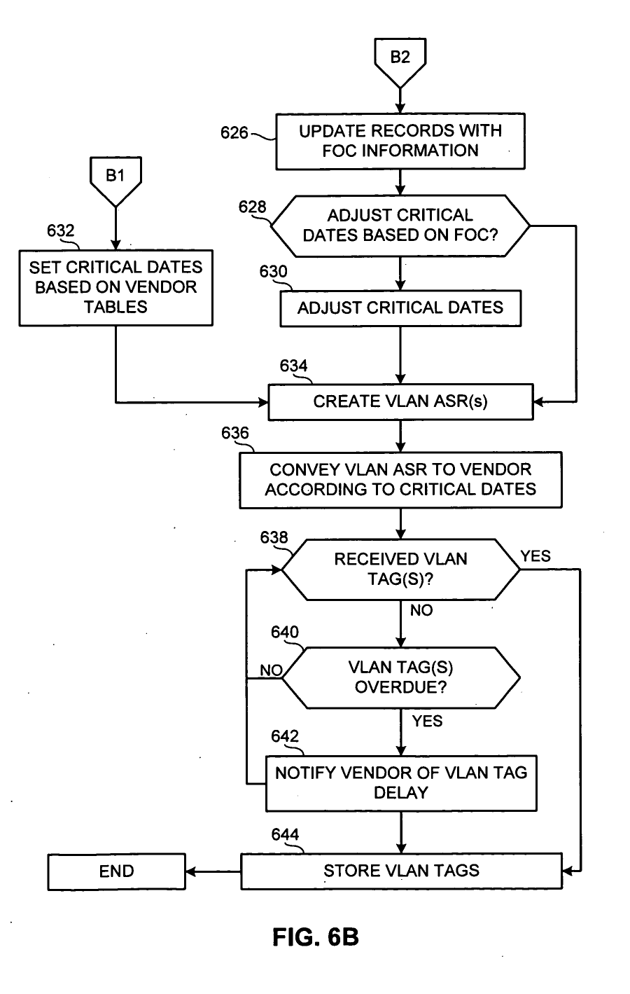

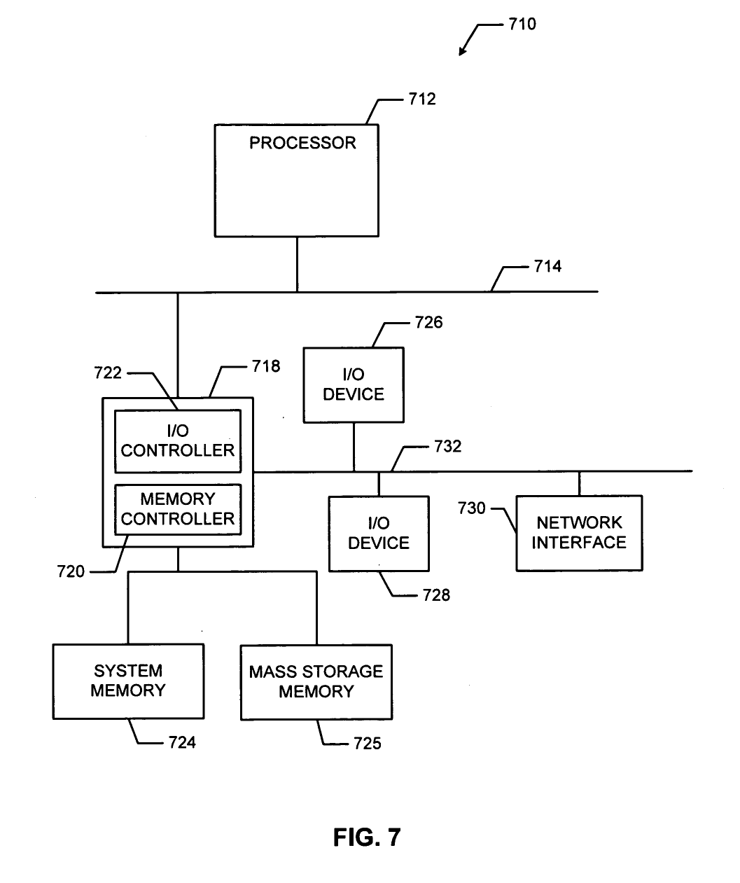

The flow diagrams depicted in FIGS. 6A and 6B are representative of machine readable instructions that can be executed to implement the example systems, methods, apparatus, and/or articles of manufacture described herein. In particular, FIGS. 6A and 6B are a flow diagram representative of example machine readable instructions that may be executed to implement the example ACMS 102 of FIG. 1 to automatically process a service order. The example processes of FIGS. 6A-B may be performed using a processor, a controller and/or any other suitable processing device. For example, the example processes of FIGS. 6A-B may be implemented in coded instructions stored on a tangible medium such as a flash memory, a read-only memory (ROM) and/or random-access memory (RAM) associated with a processor (e.g., the example processor 712 discussed below in connection with FIG. 7). Alternatively, some or all of the example processes of FIGS. 6A-B may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 6A-B may be implemented manually or as any combination(s) of any of the foregoing techniques, for example, any combination of firmware, software, discrete logic and/or hardware. Further, although the example processes of FIGS. 6A-B are described with reference to the flow diagrams of FIGS. 6A-B, other methods of implementing the processes of FIG. 6A-B may be employed. For example, the order of execution of the blocks may be changed, and/or some of the blocks described may be changed, eliminated, sub-divided, or combined. Additionally, any or all of the example processes of FIGS. 6A-B may be performed sequentially and/or in parallel by, for example, separate processing threads, processors, devices, discrete logic, circuits, etc.

To begin, the example vendor interface 128 receives a service order from the example subscriber 114 requesting connectivity to the example network 101 (block 600). The service order includes information regarding the subscriber 114, the communication device 116 at the subscriber premises 112, the type of service requested (such as a new connection, a disconnection, or a change of certain aspects of a connection), a geographic location of the subscriber premises 112, and service specifications, such as connection speed, bandwidth, etc. The record module 200 creates the entry 300 in the record database 108 and uses the information contained in the service order to populate the set of subscriber related fields 302 (block 602).

Next, the vendor selector 202 selects a vendor best suited and/or contracted to fulfill the service order (block 604). As described above, the vendor selector 202 may select one of the vendors 120a-d based on a plurality of factors including, for example, the geographic location of the subscriber premises 112, which is stored as the premises location identifier 310 in the example database entry 300 of FIG. 3. Then, the example Ethernet switch selector 204 references the vendor tables 106 to determine network device identifier(s) assigned to the geographic area in which the subscriber premises 112 is located (block 606). In the illustrated example, the network device(s) are Ethernet switches and, thus, the identifier(s) are Ethernet switch identifier(s), which are stored as the Ethernet switch identifier(s) 315 in the example database entry 300 of FIG. 3.

Then, the configuration detector 206 detects a configuration of the access network 122 that has been selected to place the subscriber premises 112 in communication with the network 101 and, according to the detected configuration, how many and what type of ASRs are necessary to establish connectivity over the selected access network 122 (block 608). For example, the configuration detector 206 may reference the service specifications identifier 312 to determine what type of network service will be provided to the subscriber 114 and, therefore, a configuration that will be implemented. The configuration detector 206 then stores a code corresponding to the detected configuration in the access network configuration identifier 316 of the database entry 300. Further, the configuration detector 206 populates the ASR amount and type field 318 of the database entry 300 of FIG. 3 with the detected and/or calculated information.

If the service order being processed requires a physical ASR according to the ASR amount and type field 318 (block 610), the ASR trigger 212 causes the ASR creator 132 to create a physical ASR using at least some of the subscriber information from the subscriber-related fields 302 and the access provider related fields 313 of the database entry 300 of FIG. 3 (block 612). For example, the ASR creator includes the Ethernet switch identifier(s) 315 to enable the vendor 120a to provision and/or configure the corresponding Ethernet switches to support a new connection, disconnection, or change of connection associated with the service order being processed. When the physical ASR is created, the vendor interface 128 conveys the physical ASR to the vendor 120a and sets the physical ASR sent date 320 of the database entry 300 of FIG. 3 to the date on which the physical ASR is sent (block 614).

Further, the critical date setter 208 then sets the critical dates 323 in the database record 300 of FIG. 3 to optimally schedule the processing of any dependent logical ASRs (block 616). In the illustrated example, the critical date setter 208 uses the database record 300 and the vendor tables 106 to set the physical access due date 324, the DVA date 326, the CTA date 328, the VLAN FOD 330, and the full connectivity date 332. As described above, the critical dates 323 and the setting thereof can depend on the type of service order being processed, such as a new connection, a disconnect, or a change in connection, and/or on which of the vendors 120a-d is selected to fulfill the service order being processed. The example critical date setter 208 is configured to set the critical dates based on a reference date, such as the physical ASR due date 324, using one or more offsets and/or variable VPTs from the VPT table 400 of FIG. 4. As a result, the scheduled date to send the logical ASR, which is the VLAN FOD 330 in the illustrated example, is optimized according to provided or learned durations of time needed for the selected vendor 120a to process the physical ASR.

As a response to the physical ASR, the ISP 100 is to receive an FOC from the vendor 120a. As described above, the FOC includes the circuit ID that has been assigned to the circuit designed by the vendor 120a to establish the connectivity to the subscriber premises 112. The logical ASR to be sent to the vendor 120a requires the circuit ID. Thus, in the illustrated example, the ASR creator 132 cannot create the logical ASR until the FOC is received from the vendor 120a. After the physical ASR has been sent (block 614), if the vendor interface 128 has not yet received the FOC (block 618), the jeopardy detector 216 determines if the FOC is overdue (block 620). For example, the example jeopardy detector 216 of FIG. 2 determines an elapsed time since the conveyance of the physical ASR to the vendor 120a (block 614) and compares the elapsed time to an example threshold. The example threshold in the illustrated example is stored in the vendor tables 120a and depends on which of the vendors 120a-d received the physical ASR.

If the jeopardy detector 216 determines that the elapsed time since the conveyance of the physical ASR to the vendor 120a exceeds the threshold (block 620), the jeopardy detector 216 sends a message to the critical date adjuster 210 and the notification unit 218 indicating that the FOC is overdue. The critical date adjuster 210 may extend one or more of the critical dates 323 to later dates depending on, for example, an extent to which the elapsed time since the conveyance of the physical ASR to the vendor 120a exceeds the threshold according to the jeopardy detector 216 (block 622). Further, the notification unit 218 conveys an indication to the vendor 120a and/or the subscriber 114 of the possible delay in providing connectivity to the network 101 and/or the access network 122 (block 624).

Returning to block 618, when the vendor 120a conveys the FOC to the ISP 100, control passes to block 626, which is part of FIG. 6B. The FOC data extractor 214 extracts the circuit ID listed therein and populates an access provider circuit ID field 322 in the database entry 300 (block 626). In the illustrated example, after the ISP 100 receives the FOC from the vendor 120a, the jeopardy detector 216 determines if any information on the FOC, as extracted by the FOC data extractor 214, indicates that any due dates have been delayed or should not be expected to be met. For example, the vendor 120a may indicate on the FOC that the originally set physical access due date 324, which is set based on agreed upon time intervals stored in the vendor tables 106, cannot be met. If such an indication is present on the FOC (block 628), the critical date adjuster 210 makes the appropriate adjustments to, for example, one or more of the critical dates 323 listed in the example database entry 300 of FIG. 3 (block 630).

Referring back to block 610, if no physical ASR is needed to process the service order (block 610), the critical date setter 208 sets the critical dates 323 in a manner similar to that at block 616 of FIG. 6A (block 632).

Next, the ASR trigger 212 causes the ASR creator 132 to create the appropriate VLAN ASRs according to the critical dates 323 of the database entry 300 and the access network related fields 313 (block 634). In particular, the example ASR creator 132 of FIG. 1 references the ASR amount and type field 318, the access network configuration identifier 316, and/or the service specifications identifier 312 to create the VLAN ASR(s). As described above, the information included in the VLAN ASR(s) enable the vendor 120a to establish the logical aspects of the connection 126, such as the assignment of VLAN tag(s) to the communication device 116 at the subscriber premises 112. The assigned VLAN tag(s), which are stored in the VLAN tag(s) field of the database entry 300, enable the communication device 116 to transfer and receive Ethernet frames over the access network 122 and/or the network 101.

When the vendor 120a has assigned the VLAN tag(s) and/or otherwise established the logical aspects of the connection 126, the vendor 120a notifies the ISP 100 and conveys the assigned VLAN tag(s) thereto. If the VLAN tag(s) have not been received by the ISP 100 (block 638), the jeopardy detector 216 determines whether the VLAN tag(s) are overdue by, for example, comparing an estimated completion date such as the full connectivity date 332 with a current date (block 640). If the jeopardy detector 216 determines that the VLAN tag(s) are overdue, the notification unit 218 informs the vendor 120a of the overdue VLAN tag(s) and/or inquires into the overdue VLAN tag(s) with the vendor 120a (block 642). Referring back to block 638, when the ISP receives the VLAN tag(s) (block 638), the record module 200 stores the VLAN tag(s) in the VLAN tag(s) field 338 of the database entry 300.

FIG. 7 is a block diagram of an example processor system 710 that may be used to execute the instructions of FIGS. 6A and/or 6B to implement the example ACMS 102 of FIG. 1. As shown in FIG. 7, the processor system 710 includes a processor 712 that is coupled to an interconnection bus 714. The processor 712 may be any suitable processor, processing unit or microprocessor. Although not shown in FIG. 7, the system 710 may be a multi-processor system and, thus, may include one or more additional processors that are different, identical or similar to the processor 712 and that are communicatively coupled to the interconnection bus 714.

The processor 712 of FIG. 7 is coupled to a chipset 718, which includes a memory controller 720 and an input/output (I/O) controller 722. The chipset 718 provides I/O and memory management functions as well as a plurality of general purpose and/or special purpose registers, timers, etc. that are accessible or used by one or more processors coupled to the chipset 718. The memory controller 720 performs functions that enable the processor 712 (or processors if there are multiple processors) to access a system memory 724 and a mass storage memory 725.

The system memory 724 may include any desired type of volatile and/or non-volatile memory such as, for example, static random access memory (SRAM), dynamic random access memory (DRAM), flash memory, read-only memory (ROM), etc. The mass storage memory 725 may include any desired type of mass storage device including hard disk drives, optical drives, tape storage devices, etc.

The I/O controller 722 performs functions that enable the processor 712 to communicate with peripheral input/output (I/O) devices 726 and 728 and a network interface 730 via an I/O bus 732. The I/O devices 726 and 728 may be any desired type of I/O device such as, for example, a keyboard, a video display or monitor, a mouse, etc. The network interface 730 may be, for example, an Ethernet device, an asynchronous transfer mode (ATM) device, an 802.11 device, a DSL modem, a cable modem, a cellular modem, etc. that enables the processor system 710 to communicate with another processor system.

While the memory controller 720 and the I/O controller 722 are depicted in FIG. 7 as separate blocks within the chipset 718, the functions performed by these blocks may be integrated within a single semiconductor circuit or may be implemented using two or more separate integrated circuits.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

1. An apparatus to enable an entity to automatically process a network access service order associated with a subscriber, comprising:
a database to store information related to a plurality of access providers, the information including estimated periods of time for respective ones of the access providers to process access service requests (ASRs); and
a service order coordinator to schedule creation and conveyance of a first ASR based on an estimated due date of a second ASR and at least one of the estimated periods of time in the database.

2. An apparatus as defined in claim 1, wherein the first ASR comprises a logical connection ASR and the second ASR comprises a physical connection ASR.

3. An apparatus as defined in claim 1, wherein the first ASR comprises a virtual local area network ASR to enable the selected access provider to configure an access network element to transfer Ethernet frames associated with a communication device of the subscriber.

4. An apparatus as defined in claim 1, further comprising a configuration detector to detect a configuration of an access network to be used to provide network connectivity to the subscriber.

5. An apparatus as defined in claim 4, wherein the configuration detector is to determine an amount of ASRs and one or more types of ASRs to be conveyed to the selected access provider by the entity.

6. An apparatus as defined in claim 1, wherein the estimated periods of time in the database have respective durations which depend on a type of the service order.

7. An apparatus as defined in claim 1, further comprising a record database to store an entry having a plurality of fields corresponding to a set of critical dates associated with the first ASR.

8. An apparatus as defined in claim 7, wherein the critical dates are determined by referencing the database.

9. An apparatus as defined in claim 7, further comprising a critical date adjuster to alter one or more of the critical dates in response to determining that a scheduled due date will be missed.

10. An apparatus as defined in claim 1, further comprising a jeopardy detector to determine if at least one of the scheduled creation or conveyance of the first ASR will be delayed.

11. An apparatus as defined in claim 1, wherein the conveyance comprises sending information to at least one of the access providers.

12. A method to enable an entity to automatically process a network access service order associated with a subscriber, comprising:
storing a first database of information related to a plurality of access providers, the information including estimated periods of time for respective ones of the access providers to process access service requests (ASRs); and
scheduling a conveyance of a first ASR based on an estimated due date of a second ASR and at least one of the estimated periods of time.

13. A method as defined in claim 12, wherein the first ASR comprises a logical connection ASR and the second ASR comprises a physical connection ASR.

14. A method as defined in claim 12, further comprising detecting a configuration of an access network to be used to provide network connectivity to the subscriber.

15. A method as defined in claim 12, wherein the estimated periods of time in the first database depend on a type of the service order.

16. A method as defined in claim 12, further comprising creating an entry in a record database, the entry having a plurality of fields corresponding to a set of critical dates associated with the first ASR.

17. A method as defined in claim 16, wherein the critical dates are determined by referencing the first database.

18. A method as defined in claim 16, further comprising adjusting one or more of the critical dates in response to determining that a scheduled due date will be missed.

19. A method as defined in claim 12, further comprising determining if the scheduled conveyance of the first ASR will be delayed.

20-27. (canceled)

28. An apparatus to enable an entity to automatically process a network access service order for network connectivity, comprising:
a service order coordinator to identify an access network element capable of providing the network connectivity, the service order coordinator to identify the access network element by referencing a vendor database using a geographic location of a subscriber premises to obtain an identifier associated with the access network element; and
an access service request (ASR) creator to create a physical connection ASR by populating fields of the ASR using the identifier and information related to a subscriber.

29. An apparatus as defined in claim 28, wherein the vendor database is to store information related to a plurality of access providers, the information including identifiers corresponding to access network elements of one or more access networks, wherein the access networks are managed by access providers.

30. An apparatus as defined in claim 28, wherein the service order coordinator is to schedule conveyance of a logical connection ASR based on an estimated due date of the physical connection ASR and an estimated period of time associated with an access provider servicing the physical connection ASR.

31. An apparatus as defined in claim 30, wherein the service order coordinator uses an offset and a provisioning time associated with the access provider servicing the physical connection ASR.

32. An apparatus as defined in claim 28, further comprising a configuration detector to detect a configuration of an access network to be used to provide the network connectivity.

33. An apparatus as defined in claim 32, wherein the configuration detector is to determine an amount of ASRs and one or more types of ASRs to be conveyed to the selected access provider by the entity.

34. An apparatus as defined in claim 28, further comprising a record database to store an entry having a plurality of fields corresponding to a set of critical dates associated with the physical connection ASR.

35-48. (canceled)
